(19) United States
(12) Patent Application Publication
(10) Pub. No.: US 2026/0170543 A1
(43) Pub. Date: Jun. 18, 2026

(54) GENERATING RANKED LISTS

(71) Applicant: Walmart Apollo, LLC, Bentonville, AR (US)

(72) Inventors: Reza Yousefi Maragheh, Los Altos, CA (US); Priyank Gupta, Duvall, WA (US); Pratheek Vadla, Sunnyvale, CA (US); Hyun Duk Cho, San Francisco, CA (US); Praveenkumar Kanumala, Newark, CA (US); Sushant Kumar, San Jose, CA (US); Kannan Achan, Saratoga, CA (US)

(21) Appl. No.: 18/981,181

(22) Filed: Dec. 13, 2024

(51) Int. Cl. G06Q 30/0601

(52) U.S. Cl. CPC G06Q 30/0631

(57) ABSTRACT

Examples related to predicting user behaviors are disclosed. An example may involve: obtaining current behavior data of a user within a current user session; obtaining historical behavior data of the user during a past time period; determining, using at least one natural language model, context data that is relevant for predicting future behavior data of the user, wherein the context data is determined based on the current behavior data and the historical behavior data; generating, using a prediction model, a ranked list of elements related to the future behavior data of the user based on the context data; and transmitting the ranked list of elements to a computing device associated with the current user session.

### TECHNICAL FIELD

This disclosure relates to systems and methods for generating ranked lists based on user behavior prediction.

### BACKGROUND

Predicting future behaviors of a user can help generating efficient and effective user recommendations. But due to limitations of existing methods, which do not sufficiently capture and utilize the context of user history, the user behavior predictions based on existing methods are not accurate and any recommendation generated thereafter is not personalized to the user.

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for providing user behavior prediction, in accordance with some embodiments;

FIG. 2 is a block diagram of a user behavior prediction device, in accordance with some embodiments;

FIG. 3 is a block diagram illustrating various portions of a system for providing user behavior prediction, in accordance with some embodiments;

FIG. 4 illustrates an example architecture of a system for providing user behavior prediction, in accordance with some embodiments;

FIG. 5 depicts an example system with a machine-readable medium that includes instructions for providing user behavior prediction, in accordance with some embodiments;

FIG. 6 shows a flowchart illustrating an example method for providing user behavior prediction, in accordance with some embodiments;

FIG. 7 shows a flowchart illustrating an example method for determining context data that is relevant for predicting future behavior data of a user, in accordance with some embodiments;

FIG. 8 shows a flowchart illustrating an example method for retrieving historical context data relevant to current behavior data, in accordance with some embodiments;

FIG. 9 shows a flowchart illustrating an example method for generating a ranked list of elements related to future behavior data of a user, in accordance with some embodiments;

FIG. 10 shows a flowchart illustrating an example method for transmitting a control signal to reorganize icons corresponding to a ranked list of elements in a graphical user interface, in accordance with some embodiments.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Improving retrieval and ranking processes for customers is crucial to a retailer as it directly affects user engagement. When customers find what they are looking for easily and quickly, it boosts their overall user experience, encouraging them to interact more frequently with the platform. This leads to an increase in customer retention and loyalty. Furthermore, providing more relevant item recommendations also plays a pivotal role for user engagement. When a retailer can accurately predict what customers might need or want based on their past interactions, personalized recommendations can be offered, further enhancing customers'shopping experience, saving their time, and increasing the likelihood of purchases.

One objective of various embodiments in the present disclosure is to develop systems and methods for accurately predicting user behaviors by refining and improving a system's ability to understand individual customer preferences based on customer context data. This will help enhancing personalization when ranking or retrieving data for the customer, and tailoring the recommendations accordingly.

In some embodiments, to achieve a more comprehensive understanding of the customer's context, the system involves understanding not just the customer's direct interactions, but also implicit needs, preferences, and behavior patterns of the customer. For instance, understanding the type of products a customer usually browses can provide valuable context, enabling the system to offer more personalized and relevant suggestions or services. The system may adaptably integrate long-term user context (e.g. historical behavior data of the user during a past time period) with short-term user context (e.g. current behavior data of the user within a current user session), and filter non-relevant parts of historical behavior data based on the current behavior.

In some embodiments, the system also creates concise and accurate user summaries to further enhance personalization. Based on the context at hand, the system can summarize the knowledge about user history to generate a context-aware user summary. This involves utilizing user history to gain insights and understanding of the user. For example, user history may include a record of past interactions, behaviors, and preferences of the user. By analyzing the user history, the system can better predict future preferences of the user and make accurate recommendations. This not only improves the user experience but also increases the likelihood of customer engagement and conversion.

In some embodiments, one or more machine learning models or large language models (LLM) can be utilized to predict user behaviors and generate personalized recommendations. For example, the system can use a first LLM (alongside with a machine learning model) to filter context data retrieved from a long term user history based on short term user session data, use a second LLM to generate summary data of filtered context, and use a third LLM to predict next items/elements interesting to the user based on the summarized context, a recall list of candidates, and a user summary of the user. This provides a novel agentic retrieval augment generation (RAG) framework to address recommendation-specific challenges, by integration of different LLM agents with a retrieval and recommendation system. Utilizing customer context through the multi-agent approach can enhance the item retrieval or recommendation process with fast and accurate results for personalized recommendation.

In some embodiments, one or more filtering and/or review processes may be implemented at various stages to identify and/or prevent generation of undesirable content by the large language models or any other model utilized by the disclosed system. For example, one or more filtering processes may be applied to identify, remove, and/or otherwise eliminate undesirable content such as inappropriate content, offensive images, restricted images, etc. Although specific embodiments are discussed herein, it will be appreciated that any suitable filtering may be applied at any suitable steps of the disclosed methods.

The disclosed method is agnostic to recommendation settings, and is adaptable to any type of recommendations, e.g. similar item recommendation, complementary item recommendation, next best item retrieval, or query-based item retrieval. The disclosed system can enhance user engagement and improve accuracy and relevance of recommendations, which contributes significantly to the improvement of key performance metrics of a retailer. For instance, the gross merchandise value (GMV) could increase as more relevant recommendations may lead to customers purchasing higher-valued items or making more frequent purchases. Similarly, the click-through rate (CTR) may show an uptick as customers are more likely to click on personalized, relevant recommendations. The conversion rate (CVR) would also increase as improved user engagement and relevant recommendations will increase the chances of customers completing a purchase.

In various embodiments, a system including a processor and a non-transitory memory storing instructions is disclosed. The instructions, when executed, cause the processor to: obtain current behavior data of a user within a current user session; obtain historical behavior data of the user during a past time period; determine, using at least one natural language model, context data that is relevant for predicting future behavior data of the user, wherein the context data is determined based on the current behavior data and the historical behavior data; generate, using a prediction model, a ranked list of elements related to the future behavior data of the user based on the context data; and transmit the ranked list of elements to a computing device associated with the current user session.

In various embodiments, a computer-implemented method is disclosed. The computer-implemented method includes: obtaining current behavior data of a user within a current user session; obtaining historical behavior data of the user during a past time period; determining, using at least one natural language model, context data that is relevant for predicting future behavior data of the user, wherein the context data is determined based on the current behavior data and the historical behavior data; generating, using a prediction model, a ranked list of elements related to the future behavior data of the user based on the context data; and transmitting the ranked list of elements to a computing device associated with the current user session.

In various embodiments, a non-transitory computer readable medium having instructions stored thereon is disclosed. The instructions, when executed by at least one processor, cause at least one device to perform operations including: obtaining current behavior data of a user within a current user session; obtaining historical behavior data of the user during a past time period; determining, using at least one natural language model, context data that is relevant for predicting future behavior data of the user, wherein the context data is determined based on the current behavior data and the historical behavior data; generating, using a prediction model, a ranked list of elements related to the future behavior data of the user based on the context data; and transmitting the ranked list of elements to a computing device associated with the current user session.

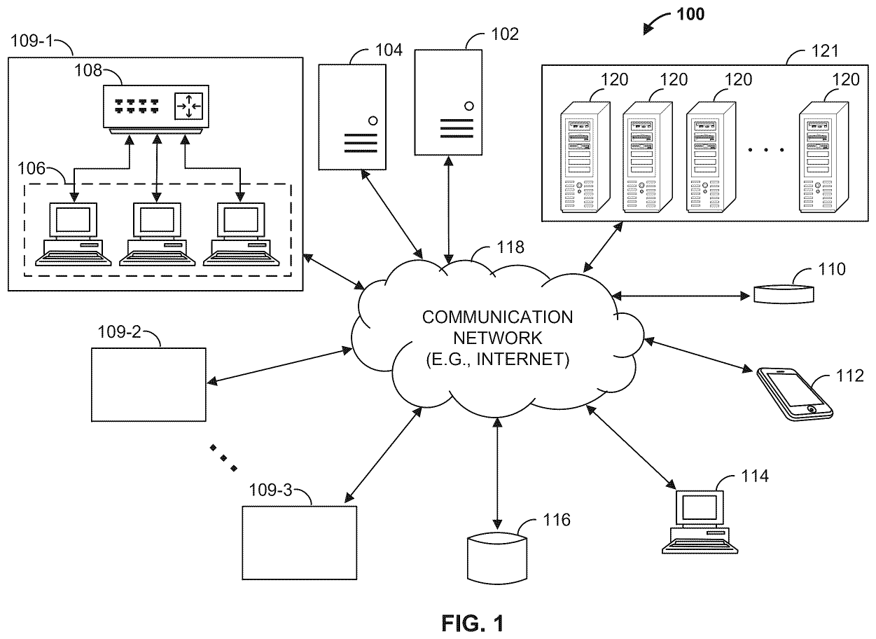

Turning to the drawings, FIG. 1 is a network environment 100 configured for providing user behavior prediction, in accordance with some embodiments. The network environment 100 includes a plurality of devices or systems that can communicate over one or more network channels, illustrated as a network cloud 118. For example, in various embodiments, the network environment 100 can include, but not limited to, a user behavior prediction device 102, a server 104 (e.g., a web server or an application server), a cloud-based engine 121 including one or more processing devices 120, workstation(s) 106, a database 116, and one or more user computing devices 110, 112, 114 operatively coupled over the network 118. The user behavior prediction device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the user behavior prediction device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more Tensor Processing Units (TPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the user behavior prediction device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the user behavior prediction device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109 (or nodes 109).

The workstation(s) 106 can communicate with the user behavior prediction device 102 over the communication network 118. The workstation(s) 106 may send data to, and receive data from, the user behavior prediction device 102. For example, the workstation(s) 106 may transmit data identifying transactions, inventory, assortment, supply chain data and/or waste data at the one or more fulfillment nodes 109 to the user behavior prediction device 102. The workstation(s) 106 may also transmit other data related to the one or more fulfillment nodes 109 to the user behavior prediction device 102.

Although FIG. 1 illustrates three user computing devices 110, 112, 114, the network environment 100 can include any number of user computing devices 110, 112, 114. Similarly, the network environment 100 can include any number of the user behavior prediction devices 102, the processing devices 120, the workstations 106, the fulfillment nodes 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer's website, hosted by the server 104. The server 104 may capture user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the user behavior prediction device 102 over the communication network 118. The website may also allow the customer to add one or more of the items to an online shopping cart, and allow the customer to perform a “checkout” of the shopping cart to purchase the items. In some examples, the server 104 transmits purchase data identifying items the customer has purchased from the website to the user behavior prediction device 102.

In some examples, the server 104 transmits a recommendation request to the user behavior prediction device 102. The recommendation request may be sent together with a search query provided by the customer (e.g., via a search bar of the web browser), or may be embedded in user session data provided in response to the customer adding one or more items to cart or interacting (e.g., engaging, clicking, or viewing) with one or more items.

In one example, a customer selects an item on a website hosted by the server 104, e.g. by clicking on the item to view its product description details, by adding it to shopping cart, or by purchasing it. The server 104 may treat the item as an anchor item or query item for the customer, and send a recommendation request to the user behavior prediction device 102. In response to receiving the request, the user behavior prediction device 102 may execute the one or more processors to determine recommended items that are related (e.g. substitute or complementary) to the anchor item, generate a ranked list of items from the recommended items based on a prediction of future behaviors of the customer, and transmit the ranked list of items to the server 104 to be displayed together with the anchor item to the customer.

In another example, a customer submits a search query on a website hosted by the server 104, e.g. by entering a query in a search bar. The server 104 may send a recommendation request to the user behavior prediction device 102. In response to receiving the request, the user behavior prediction device 102 may execute the one or more processors to first determine search results including items matching the search query, and then generate a ranked list of items from the search results based on a prediction of future behaviors of the customer. The user behavior prediction device 102 may transmit the ranked list of items to the server 104 to be displayed together with the search results to the customer.

In either of the above examples, the user behavior prediction device 102 may obtain current behavior data of a user within a current user session, and obtain historical behavior data of the user during a past time period. Using at least one natural language model, the user behavior prediction device 102 can determine context data that is relevant for predicting future behavior data of the user. The context data may be determined based on the current behavior data and the historical behavior data. Based on the context data, the ranked list of items may be generated using a prediction model. The ranked list of items may be transmitted to the server 104 as part of prediction data for predicting future behaviors of the user.

In some embodiments, the ranked list generated by the user behavior prediction device 102 may be a list of any element related to the future behavior data of the user. For example, each element in the ranked list includes at least one of: a product item, a product type, a payment method, a delivery method, or a store location.

In some embodiments, the user behavior prediction device 102 is further operable to communicate with the database 116 over the communication network 118. For example, the user behavior prediction device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the user behavior prediction device 102, in some examples, the database 116 can be a local storage device, such as a hard drive, a non-volatile memory, or a USB stick. For example, the user behavior prediction device 102 may store online purchase data received from the server 104 in the database 116. The user behavior prediction device 102 may receive in-store purchase data and node related data from different fulfillment nodes 109 and store them in the database 116. The user behavior prediction device 102 may also receive from the server 104 user session data identifying events associated with browsing sessions, and may store the user session data in the database 116. The user behavior prediction device 102 may also compute recommendation data or prediction data in response to a recommendation request received from the server 104 (or the fulfillment nodes 109), and may store the prediction data in the database 116.

In some examples, the user behavior prediction device 102 generates and/or updates different models (e.g., machine learning models, deep learning models, statistical models, algorithms, natural language models, etc.) for providing user behavior prediction. The user behavior prediction device 102 may generate training data for the models based on data including but not limited to: item features, user history data, historical sale data, historical prediction data, and historical feedback data. The user behavior prediction device 102 trains the models based on their corresponding training data, and stores the models in a database, such as in the database 116 (e.g., a cloud storage). The models, when executed by the user behavior prediction device 102, allow the user behavior prediction device 102 to generate prediction data, which may include a ranked list of elements related to predicted future behaviors of the user in a future time period.

In some examples, the user behavior prediction device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the user behavior prediction device 102 may generate insights and recommendations based on user behavior prediction.

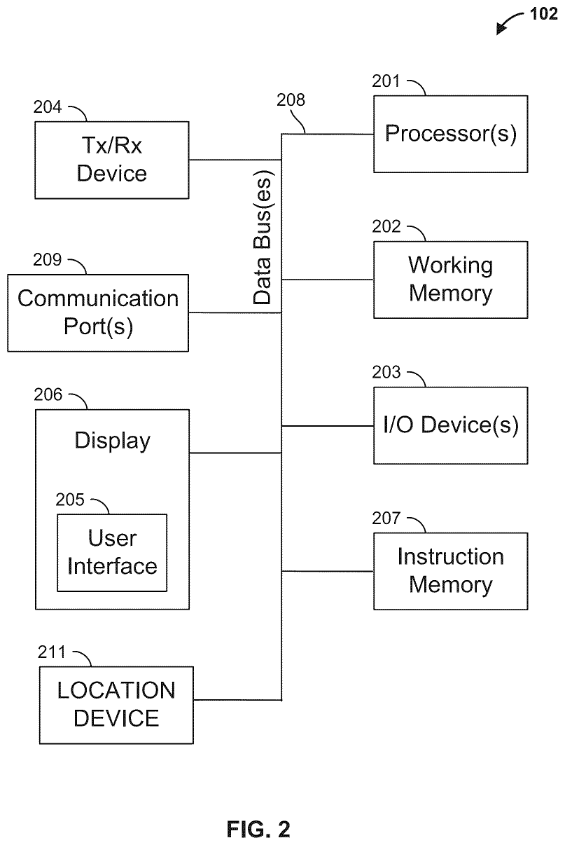

FIG. 2 illustrates a block diagram of a user behavior prediction device, e.g. the user behavior prediction device 102 of FIG. 1, in accordance with some embodiments. In some embodiments, each of the user behavior prediction device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the user behavior prediction device 102 can be combined, omitted, and/or replicated. In addition, it will be appreciated that additional elements other than those illustrated in FIG. 2 can be added to the user behavior prediction device 102.

As shown in FIG. 2, the user behavior prediction device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the user behavior prediction device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the user behavior prediction device 102 can include a single memory unit to operate as both instruction memory and working memory. Further, although embodiments are discussed herein including non-volatile memory, it will be appreciated that the user behavior prediction device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 allows communications with the cellular network. In some embodiments, the transceiver 204 is selected based on the type of the communication network 118 the user behavior prediction device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the user behavior prediction device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 may couple the user behavior prediction device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the user behavior prediction device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the user behavior prediction device 102 may determine a local geographical area (e.g., town, city, state, etc.) of its position.

In some embodiments, the user behavior prediction device 102 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

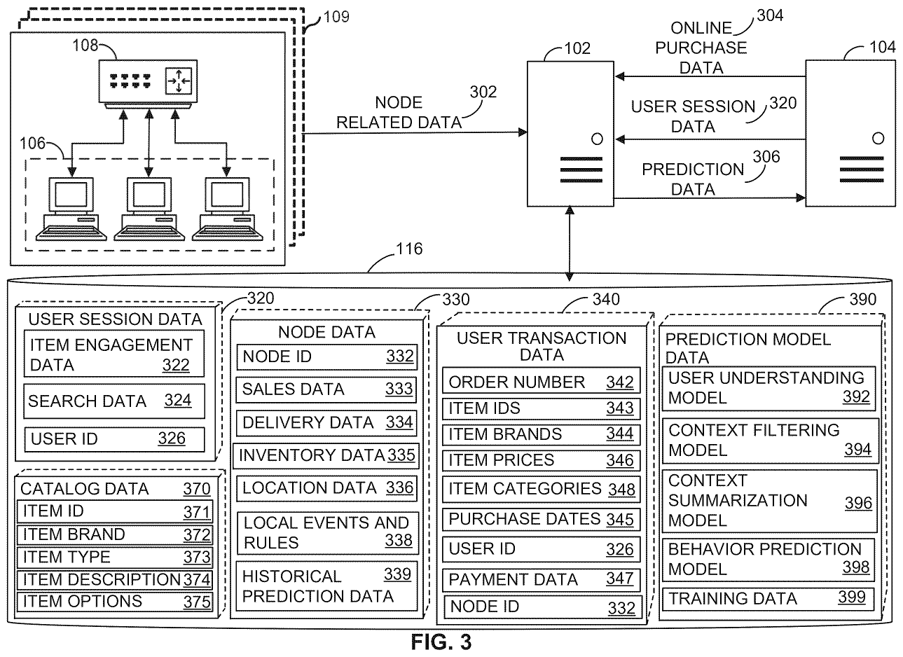

FIG. 3 is a block diagram illustrating various portions of a system for providing user behavior prediction, e.g. the system shown in the network environment 100 of FIG. 1, in accordance with some embodiments. As indicated in FIG. 3, the user behavior prediction device 102 may receive user session data 320 from the server 104, and store the user session data 320 in the database 116. The user session data 320 may identify, for each user (e.g., customer, seller, associate), data related to that user's browsing session, such as when browsing a retailer's webpage hosted by the server 104. In some embodiments, the system may not utilize all of the components and data shown in FIG. 3 for recommending and optimizing inventory target levels for items.

In some examples, the user session data 320 may include item engagement data 322, search data 324, and user ID 326 (e.g., a customer ID, seller ID, associate ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items viewed by the user, items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The user behavior prediction device 102 may also receive online purchase data 304 from the server 104, which identifies and characterizes one or more online purchases, such as purchases made by the user and other users via a retailer's website hosted by the server 104. The user behavior prediction device 102 may also receive node related data 302 from the fulfillment nodes 109, which identifies and characterizes one or more in-store purchases, product location data, inventory data, and/or assortment data related to each of the fulfillment nodes 109. In some embodiments, the node related data 302 may also indicate other information about the fulfillment nodes 109. In some embodiments, the fulfillment nodes 109 and the server 104 are associated with each other such that the online purchase data 304, the user session data 320 and the node related data 302 all come from a same server cluster or datacenter.

The user behavior prediction device 102 may parse the node related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, and node ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some examples, the user behavior prediction device 102 receives a recommendation request embedded in the user session data 320 for a customer interacting with a website hosted by the server 104. In some examples, the recommendation request may be inherent without being explicitly identified. The user session data 320 itself can also serve as a recommendation request. In some examples, the recommendation request may be associated with an anchor item or query item to be displayed to a user, e.g. after the user chooses the anchor item from a search results webpage, or after the user clicks on an advertisement or promotion related to the anchor item. In response, the user behavior prediction device 102 generates recommended items that are related (e.g. similar, substitute or complementary) to the anchor item. Then, the user behavior prediction device 102 may generate a ranked list of elements related to predicted future behaviors of the user, based on the recommended items and context data of the user, and transmit the ranked list of elements as the prediction data 306 to the server 104 for displaying the ranked list of elements together with the anchor item to the user. In various embodiments, the context data is determined based on current behavior data of the user within a current user session and based on historical behavior data of the user during a past time period, using one or more machine learning models.

The database 116 may also store prediction model data 390 identifying and characterizing one or more models and related data for providing user behavior prediction. For example, the prediction model data 390 may include: a user understanding model 392, a context filtering model 394, a context summarization model 396, a behavior prediction model 398 and training data 399. In various embodiments, the prediction model data 390 includes any number of the user understanding models 392, the context filtering models 394, the context summarization models 396, and the behavior prediction models 398.

The user understanding model 392 in this example can be used to generate a user summary reflecting a brief comprehensive understanding of a user. The user summary may be generated based on information provided in a current user session. For example, the user understanding model 392 may be a large language model used to generate the user summary based on a prompt of “return a summary of the user's preference, intent and interest based on the user's recent interaction history.” In some embodiments, the system generates a recall list of elements based on the user summary and historical behavior data of a plurality of users. The recall list of elements will be used as a pool for recommending elements to the user.

The context filtering model 394 can be used to generate filtered context data for a user, based on the user's current behavior data within a current user session and the user's historical behavior data during a past time period. In some examples, the system can retrieve, from the historical behavior data, historical context data relevant to the current behavior data, and automatically generate a first prompt based on the historical context data and a type of the elements to be included in the prediction data 306. The system can input the first prompt to the context filtering model 394 to generate the filtered context data, to enhance the understanding of user behavior in predicting the next item or element to be interacted by the user.

In some embodiments, the context filtering model 394 is a large language model trained based on a first training data set including: element metadata, user metadata, labelled textual data, semantic data, context relevancy data. In some embodiments, the first prompt input into the context filtering model 394 is generated for each given element or item in the retrieved historical context data. In one example, the first prompt may include “can the provided element enhance the understanding of user behavior?” In another example, the first prompt may include “is the provided item relevant for predicting potential purchases based on the given context?” In some embodiments, the context filtering model 394 filters out at least some of the historical context data to generate the filtered context data. The filtered context data generated by the context filtering model 394 may include a first list of context elements identified to be relevant for predicting the future behaviors of the user and include insight data explaining relevancy of the first list of context elements for the predicting.

The context summarization model 396 in this example can be used to generate a summary of the user's context data. In some examples, the system can automatically generate a second prompt based on the filtered context data generated by the context filtering model 394 and based on the user summary generated by the user understanding model 392. The system can input the second prompt to the context summarization model 396 to generate summarized context data.

In some embodiments, the context filtering model 396 is a large language model trained based on a second training data set including: at least part of the first training data set, user summary data, labelled context summary data, context formality data. In some embodiments, the second prompt input into the context summarization model 396 is generated for each given element or element corpus in the filtered context data and based on the user summary generated by the user understanding model 392. In one example, the second prompt may include “return a summary of important information present in the element corpus that will be a complement to the provided user summary,” and “skip the information that is not relevant to the user summary.”

The behavior prediction model 398 in this example can be used to generate prediction data 306 for the user. In some examples, the system can generate one or more prompts based on: the summarized context data generated by the context summarization model 396, the user summary generated by the user understanding model 392, and the recall list of elements used as a pool for recommending elements to the user. The system may input the one or more prompts to the behavior prediction model 398 to generate a ranked list of elements to be included in the prediction data 306. The ranked list of elements may be a subset of the recall list of elements.

In some embodiments, the behavior prediction model 398 is a large language model trained based on: at least part of the first training data set, at least part of the second training data set, summary data, historical and/or labelled prediction data. In some embodiments, the one or more prompts input into the behavior prediction model 398 may include “analyze the user's interaction history to understand their preferences and shopping intent,” “examine the recall list of potential items to rank,” “based on your analysis, rank the potential items in descending order of purchase likelihood,” and “return only a list of item IDs in a ranked order, with no additional text or explanations.”

In some embodiments, the user behavior prediction device 102 can transmit the ranked list of elements as part of the prediction data 306 to the server 104. In some embodiments, the prediction data 306 includes a control signal to the server 104 to reorganize icons corresponding to the ranked list of elements in a graphical user interface (GUI) presented to the user, based on rankings of the elements in the ranked list. In some examples, the user behavior prediction device 102 may further receive updated behavior data of the user within the current user session, and transmit in real-time an updated control signal to the server 104 to reorganize icons corresponding to an updated ranked list of elements in the GUI presented to the user, based on rankings of the elements in the updated ranked list. The updated behavior data may also be used to re-train at least one of the user understanding model 392, the context filtering model 394, the context summarization model 396 or the behavior prediction model 398.

In some embodiments, one or more of the user understanding model 392, the context filtering model 394, the context summarization model 396 and the behavior prediction model 398 can be implemented as a machine learning model, a natural language model, or a large language model. The training data 399 may include data utilized for training one or more of the user understanding model 392, the context filtering model 394, the context summarization model 396 and the behavior prediction model 398. In some examples, the training data 399 may be formed based on: item features, user features, historical or labelled sale data, historical or labelled user context data, historical or labelled prediction data, and historical feedback data, obtained from either real data or synthetic data.

In some embodiments, the user behavior prediction device 102 may assign one or more of the above described operations to a different processing unit or virtual machine hosted by one or more processing devices 120. Further, the user behavior prediction device 102 may obtain the outputs of these assigned operations from the processing units, and generate the prediction data 306 based on the outputs.

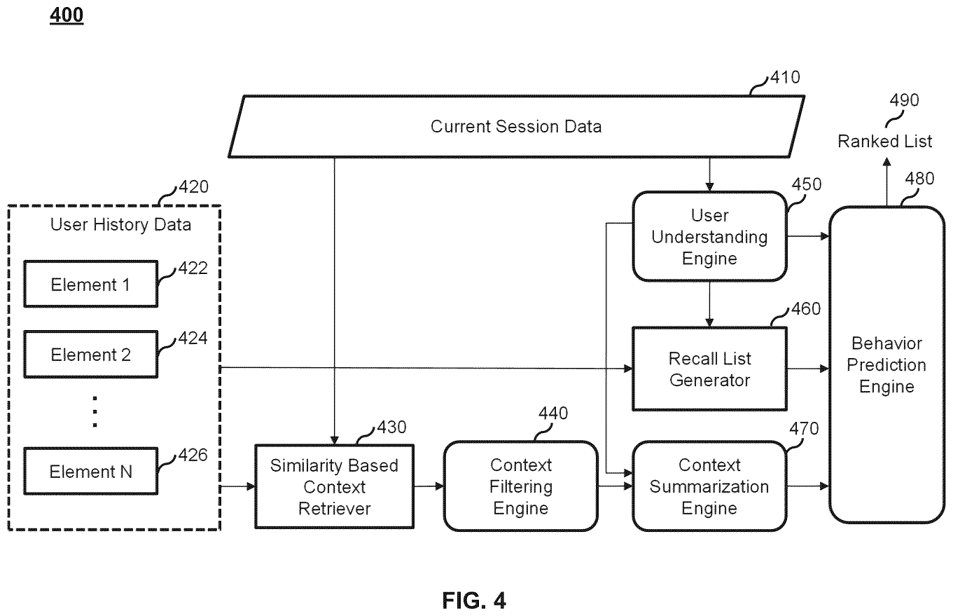

FIG. 4 illustrates an example architecture of a system for providing user behavior prediction, in accordance with some embodiments. In some embodiments, the system 400 can be implemented by one or more computing devices, such as the user behavior prediction device 102 and/or the cloud-based engine 121 of FIG. 1.

As shown in FIG. 4, the system 400 in this example includes a similarity based context retriever 430, a recall list generator 460, a context filtering engine 440, a user understanding engine 450, a context summarization engine 470 and a behavior prediction engine 480. The similarity based context retriever 430 can obtain current session data 410 of a user, e.g. from the database 116 or from the server 104. Based on the current session data 410, the similarity based context retriever 430 can retrieve some context data from the user history data 420.

In some embodiments, from the current session data 410, the similarity based context retriever 430 can determine current behavior data of the user, which may indicate items the user has interacted with in the current user session. The user history data 420 may indicate items the user has interacted with during a past time period, e.g. in the past 3 months. Each interaction in the current session data 410 and the user history data 420 is associated with an interaction type, identifying a type of interaction done by user, e.g. item view, add-to-cart, item search, item purchase, etc. The interaction type may also be one of the features used by the similarity-based context retriever 430 during context retrieval.

As shown in FIG. 4, the user history data 420 may include metadata for different elements, e.g. element 1 422, element 2 424 . . . element N 426. In general, each element may include at least one of: a product item, a product type, a payment method, a delivery method, or a store location. That is, the system 400 can recommend a ranked list of any type of these elements based on user behavior prediction. For example, the system 400 can generate a ranked list of items (or product type, product category) based on a descending order of purchase likelihood by the user. The system 400 may also generate a ranked list of stores based on a descending order of likelihood for the user to go shopping. The system 400 may also generate a ranked list of payment methods (or delivery methods) based on a descending order of likelihood for the user to use during the next purchase.

When the elements are product items, the metadata for each element may include information related to: titles of items, short descriptions (e.g. 2˜3 sentences or bullet points highlighting key features of an item beside images of the item) of items, long descriptions (e.g. several paragraphs describing item details under the item images in the product view page) of items, customer reviews for the items, and other item features like: price, brand, product type, product category, etc.

In some embodiments, the similarity based context retriever 430 retrieves most relevant elements from the user history data 420 for a given query generated based on the current session data 410, by representing the query and each element as a vector, and calculating a cosine similarity between the query vector and each element vector. In some examples, the similarity based context retriever 430 can determine at least one context element based on the historical behavior data in the user history data 420, and generate a context embedding for each of the at least one context element. The similarity based context retriever 430 can also determine at least one query element based on the current behavior data in the current session data 410. Then for each respective query element of the at least one query element, the similarity based context retriever 430 may generate a query embedding for the respective query element, compute a cosine similarity between the query embedding and each context embedding, and determine, among the historical behavior data, relevant context element data with respect to the respective query element based on the computed cosine similarity. For example, a context element data is determined to be relevant when its cosine similarity with respect to the respective query element is higher than a predetermined threshold. The similarity based context retriever 430 may retrieve the historical context data (e.g. including metadata, historical interaction data, etc.) based on the relevant context element data for each respective query element. The historical context data retrieved by the similarity based context retriever 430 may include element chunks or element corpus, which is a pool of elements identified from the user's long term history to be relevant to the user's current session context.

Based on the historical context data retrieved by the similarity based context retriever 430, the context filtering engine 440 can generate a first prompt for a first natural language model, e.g. the context filtering model 394 in the database 116, and input the first prompt with other input data to the first natural language model to generate filtered context data. The first natural language model here serves as an intelligent agent which determines if a provided element can enhance the understanding of user behavior in predicting the next element to be interacted by the user. The first natural language model may generate an identification whether a given element is relevant for predicting user behavior, and output an explanation why such identification is generated.

In some examples, the context filtering engine 440 may provide a given element, obtained from the historical context data retrieved by the similarity based context retriever 430, to the first natural language model, and input the first prompt like: “please determine if the provided element can enhance the understanding of user behavior” or “is the given element relevant for predicting potential user interactions based on the given context input data?” In some examples, the context input data provided together with the first prompt to the first natural language model may include metadata related to the given element. For example, a sample context input may include: [(a) Product Title: BRAND Women's Checkered Tote Shoulder Bag with inner pouch; (b) Short Product Description: BRAND checkered tote shoulder bag—Beige—can be used as a shoulder bag or cross body bag or a clutch—ideal for everyday occasions such as work, school, shopping, etc.—best choice for your wife/friend/mom in Mother's Day, Valentine's Day, Birthday, Christmas and other occasions; (c) Long Product Description: HIGH QUALITY MATERIAL: designed with luxury and high-quality vegan leather, FASHION STYLE: the women checkered tote bag is fashion and suit for all seasons, goes well with any clothes in any occasion like dating, traveling, working, school, shopping, never out of style, PERFECT FOR SMARTPHONES: our checkered tote bag is spacious enough for money, cards, books, iPad, cosmetics, cellphone, charger, water bottle, wallet, lunch box and more . . . big capacity handbag . . . Package Includes: 1 women checkered bag, COLOR: Brown Checkered, CLOSURE: Top Zipper closure, FEATURES: the checkered shoulder tote bag with 1 main compartment, 2 interior slide in pockets, can be used as checkered shoulder bag, shoulder tote, checkered handbags, checkered tote shoulder bag and so on, OCCASIONS: Work, Weekend, Travel, Party, Evening, Daily, Any occasion, CUSTOMER SATISFACTION: if you are not 100% satisfied with our women's handbag, tote bag, totes, clutch, or purse, you can return it for a full refund.]

When the first natural language model generates an identification whether the given element is relevant for predicting user behavior, it may also output an explanation why such identification is generated. For example, a sample explanation (for a relevant item) may include: [the element provides detailed information about the BRAND Women's Checkered Tote Shoulder Bag, which is one of the items in the user's current shopping session data; the element includes product features, customer satisfaction details, color options, and occasions for use, which can help in understanding the user's interest and potential purchase intent related to this specific item.]

After going through all the elements in the historical context data retrieved by the similarity based context retriever 430, the context filtering engine 440 can filter out irrelevant context data to generate filtered context data using the first natural language model, and provide the filtered context data to the context summarization engine 470.

The user understanding engine 450 in FIG. 4 can take the information provided in the current session data 410 and condense it into a brief comprehensive user summary, using a user understanding model, e.g. the user understanding model 392 in the database 116. In some examples, the user understanding engine 450 can automatically generate and input one or more prompts to the user understanding model to generate a user summary based on the current session data 410 of the user. For example, one prompt input into the user understanding model may include “create a brief overview of the user's shopping habits and their shopping intentions.” In some examples, the user understanding engine 450 may also input another prompt like “the tone of the summary should be in a guide-like manner to provide other agents with a clear understanding of the customer.” This is because the user summary generated by the user understanding model will be utilized by other models in the system for user behavior prediction.

In some examples, the one or more prompts are input into the user understanding model together with input data from the current session data 410. For example, a sample input data to the user understanding model may include: [‘Checkered Tote Shoulder Bag with inner pouch’, BRAND Women's Checkered Tote Shoulder Bag with inner pouch—Vegan Leather Shoulder Satchel Fashion Bags—Cream checkered′, “The Women's Hobo Bag, Cognac”, “Women's Double Loop Harness Belt, Brown”, ‘Wearable Blanket Hoodie, Oversized Sherpa Blanket Hoodie Sweatshirt Cute Hoodie for Adults Fall Kids Women Men, Warm up Neck Hoodie Blanket with Pockets (Black)’, ‘Wearable Blanket Hoodie Sweater, Oversized Blanket Hoodie with Sleeves Sherpa Sweatshirt Blanket for Women Girls and Kids, Extremely Fluffy, Warm, Cozy, Plush Hoodie Blanket’, “Comfort Flat Women's Slip-On Shoes (Wide Widths Available)”, “Women's Collection Pointed Toe Flat Stripe Faux Leather 10 W”, “Women's Mid Rise Skinny Jeans, Regular and Short Inseams”].

Based on the one or more prompts and the input data, the user understanding model may output a user summary for the user. For example, a sample user summary may include: [Based on the user's recent interaction history, it is evident that the user has been browsing a variety of items ranging from women's fashion accessories like bags, belts, and shoes to clothing items such as jeans and tops. Additionally, the user has shown interest in cozy and comfortable items like wearable blanket hoodies. The user seems to have a preference for vegan leather products and checkered designs in bags. The user has also explored different styles of flats and heels in footwear. Moreover, the user has engaged with both regular and plus-size clothing options, indicating a diverse range of preferences.]

After generating the user summary, the user understanding engine 450 can provide the user summary to the recall list generator 460 to generate a recall list of elements, provide the user summary to the context summarization engine 470 to generate summarized context data, and provide the user summary to the behavior prediction engine 480 to predict user behaviors.

The recall list generator 460 in FIG. 4 can obtain the user summary from the user understanding engine 450, and generate a recall list of elements based on the user summary from the user understanding engine 450 and historical behavior data of a plurality of users from the user history data 420. In some examples, the recall list includes elements determined to be similar or relevant to the user summary, based on the plurality of users'history data, including all of the users'historical interactions and purchases. The recall list of elements can be treated as a raw list of elements to be ranked and/or selected for recommendation. The recall list generator 460 can provide the recall list of elements to the behavior prediction engine 480 to generate a ranked list 490 of elements for recommendation.

The context summarization engine 470 in FIG. 4 can obtain the filtered context data from the context filtering engine 440 and obtain the user summary from the user understanding engine/agent 450. The context summarization engine 470 may automatically generate a second prompt for a second natural language model, e.g. the context summarization model 396 in the database 116, and input the second prompt to the second natural language model to generate summarized context data. In some examples, the context summarization engine 470 may provide a given element, obtained from the filtered context data generated by the context filtering engine 440, together with the user summary to the second natural language model, and input the second prompt to the second natural language model to generate the summarized context data. In some examples, the second prompt may include “return a summary of important information present in the element that will be a complement to the provided user summary,” and “skip the information that is not relevant to the user summary.”

After going through all the elements in the filtered context data generated by the context filtering engine 440, the context summarization engine 470 can generate summarized context data relevant to the user summary using the second natural language model, and provide the summarized context data to the behavior prediction engine 480 to predict user behaviors.

In some embodiments, the context summarization engine 470 further filters out irrelevant context data based on the user summary from the user understanding engine 450. For example, the system 400 may generate a ranked list of stores based on a descending order of likelihood for a user to go shopping. If the user summary indicates that the user shows interests merely on electronic items, all grocery stores can be removed from the summarized context data.

The behavior prediction engine 480 in FIG. 4 can obtain the user summary from the user understanding engine 450, obtain the recall list of elements from the recall list generator 460, and obtain the summarized context data from the context summarization engine 470. The behavior prediction engine 480 may automatically generate one or more prompts for a behavior prediction model, e.g. the behavior prediction model 398 in the database 116, and input the one or more prompts to the behavior prediction model to generate the ranked list 490 of elements. In some examples, the ranked list 490 is a re-ranking of the recall list of elements. In some examples, the ranked list 490 is a subset of the recall list of elements. In some examples, the prompts input into the behavior prediction model may include: e.g. “analyze the user's interaction history to understand preferences and shopping intent of the user,” “examine the recall list of elements to rank,” “based on your analysis, rank the potential items in descending order of interaction likelihood,” and “return only a list of item IDs in the ranked order, with no additional text or explanations.” In some embodiments, the ranked list 490 of elements is output together with reasons for the ranking.

As such, the system 400 solves a ranking task for element recommendation, given a current user session and understandings obtained from long term user behavior. Given inputs including the current user session behavior, long term user behavior over the past sessions, and a recall set of items to be ranked, the system 400 outputs a ranked list 490 based on the recall set of items.

In some embodiments, different components in FIG. 4 serve as intelligent agents that can cooperate to generate the ranked list 490 with reason and insight data. For example, the user understanding engine 450 may determine a user summary that: [Based on the user's recent interaction history, it is evident that the user has been browsing a variety of items ranging from women's fashion accessories like bags, belts, and shoes to clothing items such as jeans and tops. Additionally, the user has shown interest in cozy and comfortable items like wearable blanket hoodies. The user seems to have a preference for vegan leather products and checkered designs in bags. The user has also explored different styles of flats and heels in footwear. Moreover, the user has engaged with both regular and plus-size clothing options, indicating a diverse range of preferences.] In accordance with the user summary, the context summarization engine 470 may identify a first item as [relevant], with a reason that: [The item provides detailed information about the BRAND Women's Checkered Tote Shoulder Bag, which is one of the items in the user's current shopping session data. The item includes product features, customer satisfaction details, color options, and occasions for use, which can help in understanding the user's interest and potential purchase intent related to this specific item.] In accordance with the user summary, the context summarization engine 470 may identify a second item as [not relevant], with a reason that: [The item is not relevant as it focuses on a Women's Camo Performance Pullover Fleece Hoodie, which is not directly related to the current shopping session items such as bags, shoes, and jeans. The content of the item does not align with the user's current browsing patterns or preferences.] Based on the user's current session data and shopping preferences, the behavior prediction engine 480 may generate the ranked list 490 of potential items in descending order of purchase likelihood, e.g. including [Item ID: 1, Reason: The item “Checkered Tote Shoulder Handbags Bag with inner pouch PU Vegan Leather” closely aligns with the user's demonstrated interest in tote bags made of vegan leather. The user has interacted with similar items in the current session, indicating a high likelihood of purchase.], [Item ID: 2, Reason: The item “Hobo Handbag Vegan Leather Tote Chain Shoulder Purse for Women Satchel Bag With Matching Clutch”fits the user's preference for vegan leather products and stylish accessories like belts. The design and functionality of this item make it a strong contender for the user's purchase consideration.], [Item ID: 3, Reason: The item “Women's Large Tote PU Leather Bag and Handbags Top Handle Satchel Bags Big Capacity Fashion Ladies Tote Bags for Women, Brown” offers a spacious and fashionable tote bag option made of PU leather, which resonates with the user's interest in trendy and functional fashion items.], etc.

In some examples, the user understanding engine 450 may determine a user summary that: [Based on the user's recent interaction history, it is evident that the user is interested in a variety of clothing and footwear items. The user has engaged with items such as jeans, slide sandals, cowboy boots, t-shirt dresses, and leggings. This indicates a preference for casual and comfortable clothing options. Furthermore, the user has shown interest in different brands and styles. This suggests that the user is open to exploring different brands and fashion trends.] In accordance with the user summary, the context summarization engine 470 may identify a first item as [relevant], with a reason that: [The item contains information about women's wide-leg jeans, which aligns with the user's current session data that includes women's clothing items such as jeans, boots, and dresses. The item provides details about the product, its description, material, size range, and reviews, which can help in understanding the user's preferences and potential purchase intent related to women's apparel.] In accordance with the user summary, the context summarization engine 470 may identify a second item as [not relevant], with a reason that: [The item is not relevant for predicting potential purchase items based on the given context because it focuses on a different product category (sweatshirts) than the items in the user's current shopping session (clothing and footwear). There are no clear connections or similarities between the items in the session and the content of the item.] Based on the user's current session data and shopping preferences, the behavior prediction engine 480 may generate the ranked list 490 of potential items in descending order of purchase likelihood, e.g. including [Item ID: X (ranked number 1), Reason: The Women's Embroidered Tall Western Boots align well with the user's interest in stylish and practical footwear. The user has engaged with similar items like cowboy boots and moto boots, indicating a preference for versatile and fashionable shoe options] . . . [Item ID: Y (ranked number 7), Reason: The Toy Story Jessie Toddler Girls Cowgirl Boots are unlikely to match the user's shopping intent as they have mainly engaged with adult-sized clothing items. The user's interest seems centered around practical and stylish pieces for personal use, making toddler boots less relevant], etc.

In some examples, the user understanding engine 450 may determine a user summary that: [Based on the user's recent interaction history, it is evident that the user has been actively browsing and engaging with a variety of men's house slippers. The user seems to be interested in memory foam house slippers with features like non-slip soles, faux fur lining, and indoor/outdoor functionality. The shopping intentions appear to be focused on finding comfortable and warm house slippers for indoor use. To cater to this user's preferences, it would be beneficial to recommend similar styles of men's house slippers with memory foam and non-slip features.] In accordance with the user summary, the context summarization engine 470 may identify a first item as [relevant], with a reason that: [The item provides detailed information about men's cozy moccasin slippers with memory foam and rubber sole, which aligns with the user's current session data of men's house slippers with memory foam. The item describes the features, comfort, durability, and ideal use of the slippers, making it relevant for understanding the user's potential purchase intent.] Based on the user's current session data and shopping preferences, the behavior prediction engine 480 may generate the ranked list 490 of potential items in descending order of purchase likelihood, e.g. including [Item ID: 11, “G Men's Comfort Thong Sandals”, Reason: While these are sandals and not slippers, they are from a brand the user has interacted with in the current session. The memory foam feature might appeal to the user's preference for comfort], [Item ID: 22, “J Men's Comfort Slide Sandals”, Reason: These slide sandals offer a comfort element that aligns with the user's interest in memory foam house slippers. The user might consider these for a different style option], [Item ID: 33, “A Slippers Women's Sandals Flip Flops Massage Comfortable Casual Summer Slides Shoes”, Reason: Although these are women's sandals, the comfort and casual style might attract the user who values comfort in footwear.], etc.

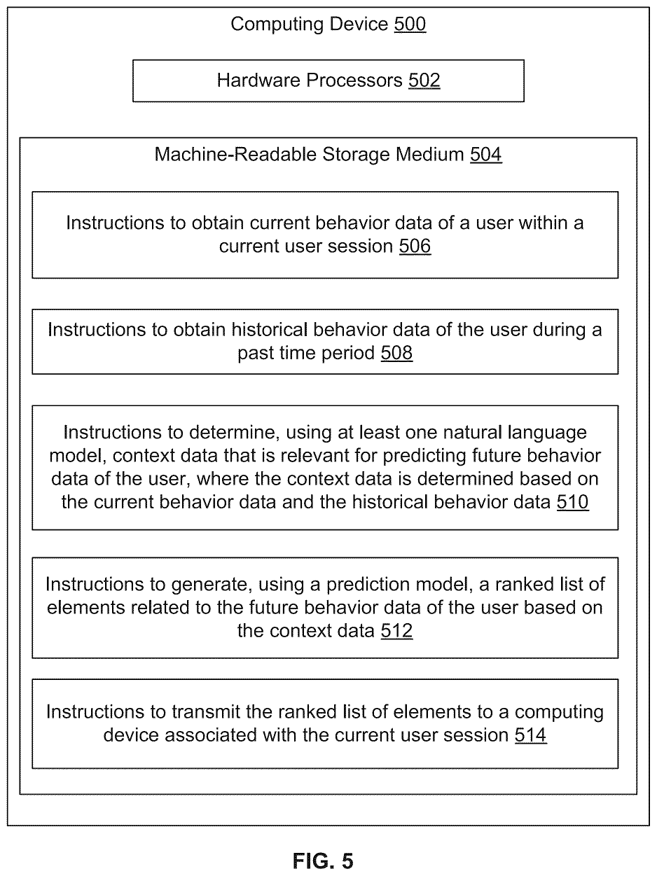

FIG. 5 depicts an example system 500 (e.g. a computing device) for providing user behavior prediction, including a machine-readable medium 504 encoded with example instructions executable by processing resource 502, e.g. hardware processors, in accordance with some embodiments. In some implementations, the system 500 may be useful for implementing aspects of the system 400 of FIG. 4. In some implementations, functionality described with respect to FIG. 4 may be included in the instructions encoded on machine-readable medium 504.

The processing resource 502 may include a microcontroller, a microprocessor, central processing unit core(s), an ASIC, an FPGA, and/or other hardware device suitable for retrieval and/or execution of instructions from the machine-readable medium 504 to perform functions related to various examples. Additionally or alternatively, the processing resource 502 may include or be coupled to electronic circuitry or dedicated logic for performing some or all of the functionality of the instructions described herein.

The machine-readable medium 504 may be any medium suitable for storing executable instructions, such as RAM, ROM, EEPROM, flash memory, a hard disk drive, an optical disc, or the like. In some example implementations, the machine-readable medium 504 may be a tangible, non-transitory medium. The machine-readable medium 504 may be disposed within the system 500 in which case the executable instructions may be deemed installed or embedded on the system. Alternatively, the machine-readable medium 504 may be a portable (e.g., external) storage medium, and may be part of an installation package.

As described further herein below, the machine-readable medium 504 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 5.

The machine-readable medium 504 includes instructions 506-514. Instructions 506, when executed, cause the processing resource 502 to obtain current behavior data of a user within a current user session. The instructions 508, when executed, cause the processing resource 502 to obtain historical behavior data of the user during a past time period.

Instructions 510, when executed, cause the processing resource 502 to determine, using at least one natural language model, context data that is relevant for predicting future behavior data of the user. The context data is determined based on the current behavior data and the historical behavior data. The instructions 512, when executed, cause the processing resource 502 to generate, using a prediction model, a ranked list of elements related to the future behavior data of the user based on the context data. The instructions 514, when executed, cause the processing resource 502 to transmit the ranked list of elements to a computing device associated with the current user session.

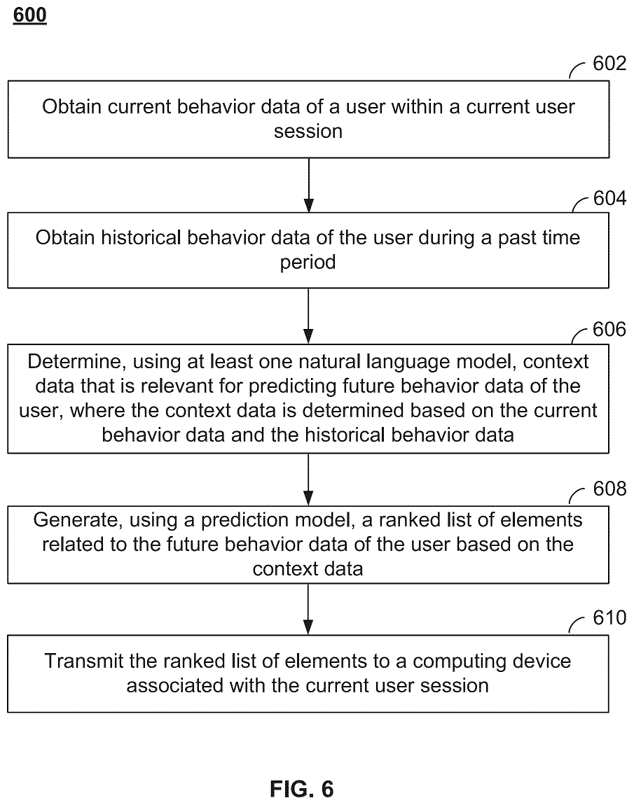

FIG. 6 shows a flowchart illustrating an example method 600 for providing user behavior prediction, in accordance with some embodiments. In some embodiments, the method 600 can be carried out by a system including one or more computing devices, such as the user behavior prediction device 102 and/or the cloud-based engine 121 of FIG. 1. Beginning at operation 602, current behavior data of a user within a current user session is obtained. At operation 604, historical behavior data of the user during a past time period is obtained. At operation 606, context data that is relevant for predicting future behavior data of the user is determined using at least one natural language model. The context data is determined based on the current behavior data and the historical behavior data. At operation 608, based on the context data, a ranked list of elements related to the future behavior data of the user is generated using a prediction model. The ranked list of elements is transmitted at operation 610 to a computing device associated with the current user session.

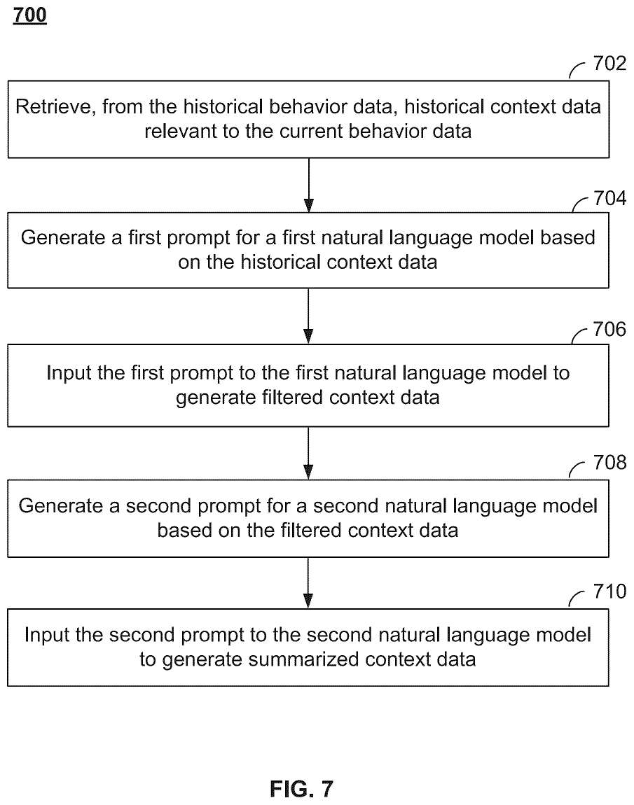

FIG. 7 shows a flowchart illustrating an example method 700 for determining context data that is relevant for predicting future behavior data of a user, in accordance with some embodiments. In some embodiments, the method 700 can be carried out by a system including one or more computing devices, such as the user behavior prediction device 102 and/or the cloud-based engine 121 of FIG. 1. In some embodiments, the method 700 can be performed as part of the operation 606 of the example method 600 in FIG. 6. Beginning at operation 702, historical context data relevant to the current behavior data is retrieved from the historical behavior data. At operation 704, a first prompt is generated for a first natural language model based on the historical context data. At operation 706, the first prompt is input to the first natural language model to generate filtered context data. At operation 708, a second prompt is generated for a second natural language model based on the filtered context data. At operation 710, the second prompt is input to the second natural language model to generate summarized context data.

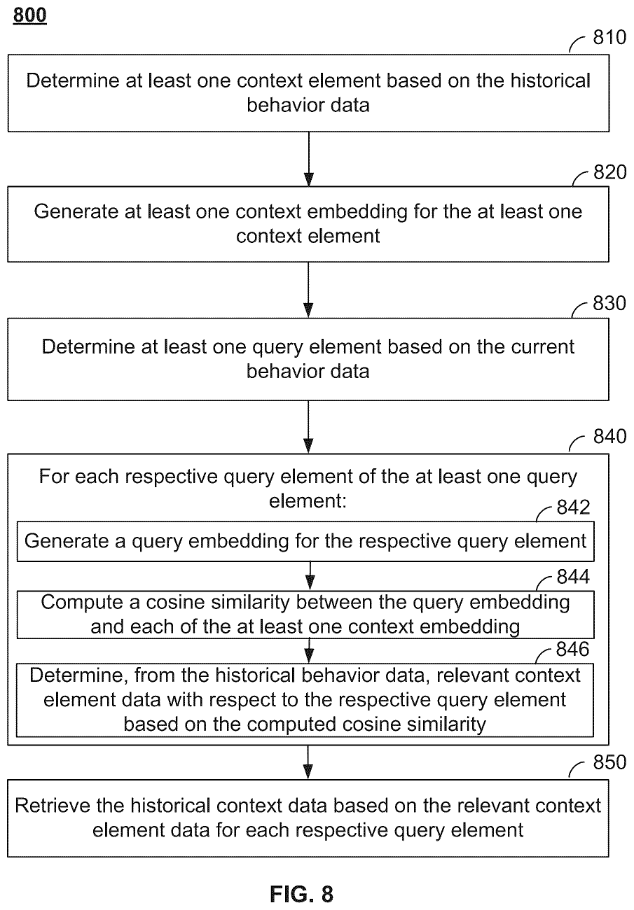

FIG. 8 shows a flowchart illustrating an example method 800 for retrieving historical context data relevant to current behavior data, in accordance with some embodiments. In some embodiments, the method 800 can be carried out by a system including one or more computing devices, such as the user behavior prediction device 102 and/or the cloud-based engine 121 of FIG. 1. In some embodiments, the method 800 can be performed as part of the operation 702 of the example method 700 in FIG. 7. Beginning at operation 810, at least one context element is determined based on the historical behavior data. At operation 820, at least one context embedding is generated for the at least one context element. At operation 830, at least one query element is determined based on the current behavior data. The operation 840 includes operations 842-846, which are performed for each respective query element of the at least one query element. At operation 842, a query embedding for the respective query element is generated. At operation 844, a cosine similarity between the query embedding and each of the at least one context embedding is computed. At operation 846, relevant context element data with respect to the respective query element is determined from the historical behavior data based on the computed cosine similarity. At operation 850, the historical context data is retrieved based on the relevant context element data for each respective query element.

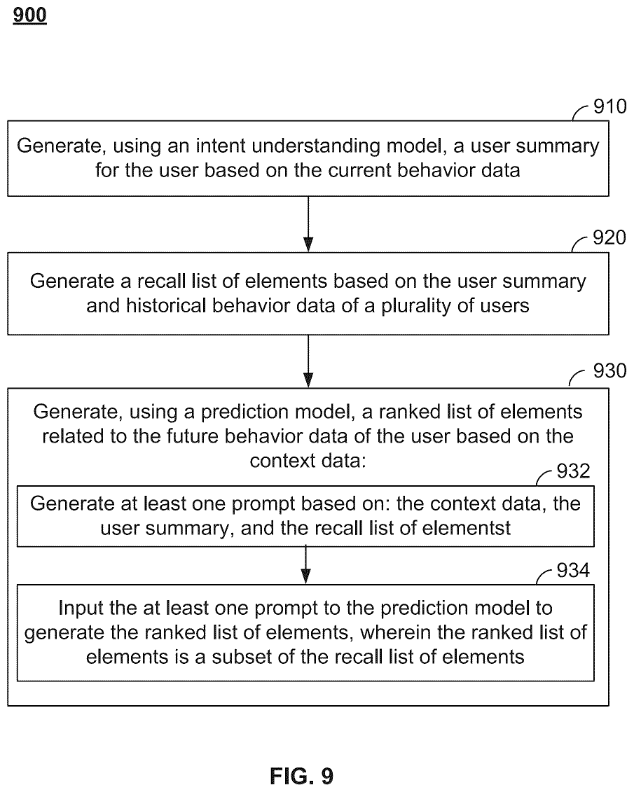

FIG. 9 shows a flowchart illustrating an example method 900 for generating a ranked list of elements related to future behavior data of a user, in accordance with some embodiments. In some embodiments, the method 900 can be carried out by a system including one or more computing devices, such as the user behavior prediction device 102 and/or the cloud-based engine 121 of FIG. 1. Beginning at operation 910, a user summary is generated for the user based on the current behavior data using an intent understanding model. At operation 920, a recall list of elements is generated based on the user summary and historical behavior data of a plurality of users. At operation 930, a ranked list of elements related to the future behavior data of the user is generated using a prediction model based on the context data. The operation 930 further includes operations 932-934. At operation 932, at least one prompt is generated based on: the context data, the user summary, and the recall list of elements. At operation 934, the at least one prompt is input to the prediction model to generate the ranked list of elements. The ranked list of elements is a subset of the recall list of elements.

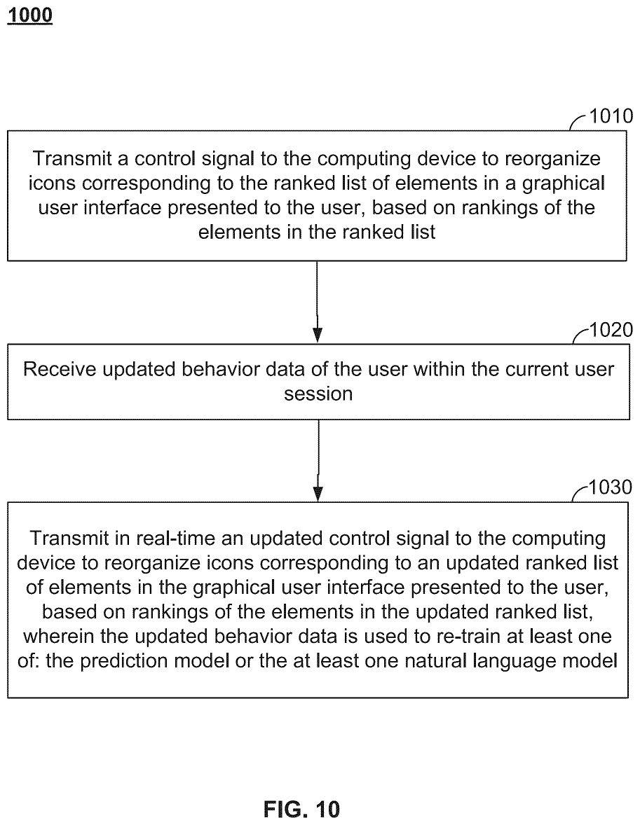

FIG. 10 shows a flowchart illustrating an example method 1000 for transmitting a control signal to reorganize icons corresponding to a ranked list of elements in a graphical user interface, in accordance with some embodiments. In some embodiments, the method 1000 can be carried out by a system including one or more computing devices, such as the user behavior prediction device 102 and/or the cloud-based engine 121 of FIG. 1. Beginning at operation 1010, a control signal is transmitted to the computing device to reorganize icons corresponding to the ranked list of elements in a graphical user interface presented to the user, based on rankings of the elements in the ranked list. At operation 1020, updated behavior data of the user is received within the current user session. At operation 1030, an updated control signal is transmitted in real-time to the computing device to reorganize icons corresponding to an updated ranked list of elements in the graphical user interface presented to the user, based on rankings of the elements in the updated ranked list. The updated behavior data is used to re-train at least one of: the prediction model or the at least one natural language model.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
obtain current behavior data of a user within a current user session,
obtain historical behavior data of the user during a past time period,
determine, using at least one natural language model, context data that is relevant for predicting future behavior data of the user, wherein the context data is determined based on the current behavior data and the historical behavior data,
generate, using a prediction model, a ranked list of elements related to the future behavior data of the user based on the context data, and
transmit the ranked list of elements to a computing device associated with the current user session.

2. The system of claim 1, wherein each element in the ranked list includes at least one of: a product item, a product type, a payment method, a delivery method, or a store location.

3. The system of claim 1, wherein:
the at least one natural language model comprises multiple natural language models; and
the context data is determined based on:
retrieving, from the historical behavior data, historical context data relevant to the current behavior data,
generating a first prompt for a first natural language model of the multiple natural language models based on the historical context data,
inputting the first prompt to the first natural language model to generate filtered context data,
generating a second prompt for a second natural language model of the multiple natural language models based on the filtered context data, and
inputting the second prompt to the second natural language model to generate summarized context data.

4. The system of claim 3, wherein retrieving the historical context data comprises:
determining at least one context element based on the historical behavior data;
generating at least one context embedding for the at least one context element;
determining at least one query element based on the current behavior data;
for each respective query element of the at least one query element,
generating a query embedding for the respective query element,
computing a cosine similarity between the query embedding and each of the at least one context embedding, and
determining, from the historical behavior data, relevant context element data with respect to the respective query element based on the computed cosine similarity; and
retrieving the historical context data based on the relevant context element data for each respective query element.

5. The system of claim 3, wherein:
the first prompt is automatically generated based on the historical context data and a type of the elements to be included in the ranked list; and
the first natural language model is trained based on a first training data set including: element metadata, user metadata, labelled textual data, semantic data, context relevancy data.

6. The system of claim 5, wherein:
the first natural language model filters out at least some of the historical context data to generate the filtered context data; and
the filtered context data includes a first list of context elements identified to be relevant for predicting the future behavior data of the user and includes insight data explaining relevancy of the first list of context elements for the predicting.

7. The system of claim 5, wherein:
the second prompt is automatically generated based on the filtered context data and a user summary of the user; and
the second natural language model is trained based on a second training data set including: at least part of the first training data set, user summary data, labelled context summary data, context formality data.

8. The system of claim 1, wherein the instructions, when executed, further cause the processor to:
generate, using an intent understanding model, a user summary for the user based on the current behavior data; and
generate a recall list of elements based on the user summary and historical behavior data of a plurality of users.

9. The system of claim 8, wherein the ranked list of elements is generated based on:
generating at least one prompt based on: the context data, the user summary, and the recall list of elements; and
inputting the at least one prompt to the prediction model to generate the ranked list of elements, wherein the ranked list of elements is a subset of the recall list of elements.

10. The system of claim 1, wherein the instructions, when executed, further cause the processor to:
transmit a control signal to the computing device to reorganize icons corresponding to the ranked list of elements in a graphical user interface presented to the user, based on rankings of the elements in the ranked list;
receive updated behavior data of the user within the current user session; and
transmit in real-time an updated control signal to the computing device to reorganize icons corresponding to an updated ranked list of elements in the graphical user interface presented to the user, based on rankings of the elements in the updated ranked list,
wherein the updated behavior data is used to re-train at least one of: the prediction model or the at least one natural language model.

11. A computer-implemented method, comprising:
obtaining current behavior data of a user within a current user session;
obtaining historical behavior data of the user during a past time period;
determining, using at least one natural language model, context data that is relevant for predicting future behavior data of the user, wherein the context data is determined based on the current behavior data and the historical behavior data;
generating, using a prediction model, a ranked list of elements related to the future behavior data of the user based on the context data; and
transmitting the ranked list of elements to a computing device associated with the current user session.

12. The computer-implemented method of claim 11, wherein:
the at least one natural language model comprises multiple natural language models; and
determining the context data comprises:
retrieving, from the historical behavior data, historical context data relevant to the current behavior data,
generating a first prompt for a first natural language model of the multiple natural language models based on the historical context data,
inputting the first prompt to the first natural language model to generate filtered context data,
generating a second prompt for a second natural language model of the multiple natural language models based on the filtered context data, and
inputting the second prompt to the second natural language model to generate summarized context data.

13. The computer-implemented method of claim 12, wherein retrieving the historical context data comprises:
determining at least one context element based on the historical behavior data;
generating at least one context embedding for the at least one context element;
determining at least one query element based on the current behavior data;
for each respective query element of the at least one query element,
generating a query embedding for the respective query element,
computing a cosine similarity between the query embedding and each of the at least one context embedding, and
determining, from the historical behavior data, relevant context element data with respect to the respective query element based on the computed cosine similarity; and
retrieving the historical context data based on the relevant context element data for each respective query element.

14. The computer-implemented method of claim 12, wherein:
the first prompt is automatically generated based on the historical context data and a type of the elements to be included in the ranked list;
the first natural language model is trained based on a first training data set including: element metadata, user metadata, labelled textual data, semantic data, context relevancy data;
the first natural language model filters out at least some of the historical context data to generate the filtered context data; and
the filtered context data includes a first list of context elements identified to be relevant for predicting the future behavior data of the user and includes insight data explaining relevancy of the first list of context elements for the predicting.

15. The computer-implemented method of claim 14, wherein:
the second prompt is automatically generated based on the filtered context data and a user summary of the user; and
the second natural language model is trained based on a second training data set including: at least part of the first training data set, user summary data, labelled context summary data, context formality data.

16. The computer-implemented method of claim 11, further comprising:
generating, using an intent understanding model, a user summary for the user based on the current behavior data;
generating a recall list of elements based on the user summary and historical behavior data of a plurality of users, wherein generating the ranked list of elements comprises:
generating at least one prompt based on: the context data, the user summary, and the recall list of elements, and
inputting the at least one prompt to the prediction model to generate the ranked list of elements, wherein the ranked list of elements is a subset of the recall list of elements.

17. The computer-implemented method of claim 11, further comprising:
transmitting a control signal to the computing device to reorganize icons corresponding to the ranked list of elements in a graphical user interface presented to the user, based on rankings of the elements in the ranked list;
receiving updated behavior data of the user within the current user session; and
transmitting in real-time an updated control signal to the computing device to reorganize icons corresponding to an updated ranked list of elements in the graphical user interface presented to the user, based on rankings of the elements in the updated ranked list,
wherein the updated behavior data is used to re-train at least one of: the prediction model or the at least one natural language model.

18. A non-transitory computer readable medium having instructions stored thereon, wherein the instructions, when executed by at least one processor, cause at least one device to perform operations comprising:
obtaining current behavior data of a user within a current user session;
obtaining historical behavior data of the user during a past time period;
determining, using at least one natural language model, context data that is relevant for predicting future behavior data of the user, wherein the context data is determined based on the current behavior data and the historical behavior data;
generating, using a prediction model, a ranked list of elements related to the future behavior data of the user based on the context data; and
transmitting the ranked list of elements to a computing device associated with the current user session.

19. The non-transitory computer readable medium of claim 18, wherein:
the at least one natural language model comprises multiple natural language models; and
determining the context data comprises:
retrieving, from the historical behavior data, historical context data relevant to the current behavior data,
generating a first prompt for a first natural language model of the multiple natural language models based on the historical context data,
inputting the first prompt to the first natural language model to generate filtered context data,
generating a second prompt for a second natural language model of the multiple natural language models based on the filtered context data, and
inputting the second prompt to the second natural language model to generate summarized context data.

20. The non-transitory computer readable medium of claim 19, wherein retrieving the historical context data comprises:
determining at least one context element based on the historical behavior data;
generating at least one context embedding for the at least one context element;
determining at least one query element based on the current behavior data;
for each respective query element of the at least one query element,
generating a query embedding for the respective query element,
computing a cosine similarity between the query embedding and each of the at least one context embedding, and
determining, from the historical behavior data, relevant context element data with respect to the respective query element based on the computed cosine similarity; and
retrieving the historical context data based on the relevant context element data for each respective query element.
